(19) United States
(12) Patent Application Publication
(10) Pub. No.: US 2026/0235893 A1
(43) Pub. Date: Aug. 13, 2026

(54) OPTICAL PHASE TRIMMING FOR SILICON OR OTHER PHOTONIC DEVICES

(71) Applicant: Raytheon Company, Arlington, VA (US)

(72) Inventors: Liangshun Han, La Jolla, CA (US); Ping Piu Kuo, San Diego, CA (US); Ivan Shubin, San Diego, CA (US)

(21) Appl. No.: 19/053,022

(22) Filed: Feb. 13, 2025

(51) Int. Cl. G02F 1/01; G02F 1/015

(52) U.S. Cl. CPC G02F 1/0147; G02F 1/0113; G02F 1/0151; G02F 2202/06; G02F 2203/50

(57) ABSTRACT

A photonic component includes a substate and a dielectric layer disposed over the substrate. The photonic component also includes a waveguide section disposed within the dielectric layer and a heating element disposed within the dielectric layer and configured to transfer heat to the waveguide section. In addition, the photonic component includes one or more cavities in the substrate disposed below the waveguide section and the heating element, where the one or more cavities is configured to confine heat in an area of interest to reach an elevated temperature within and around the waveguide section.

### TECHNICAL FIELD

This disclosure relates generally to photonic devices. More specifically, this disclosure relates to optical phase trimming for silicon or other photonic devices.

### BACKGROUND

Silicon photonics have been widely adopted in optical communication systems since silicon photonics often share fabrication infrastructures with complementary metal oxide semiconductor (CMOS) devices. Additionally, very high refractive index contrasts between silicon core layers and dielectric cladding layers used in silicon photonics enable large-scale and high-density integration on a single chip. However, high refractive index contrasts also cause phase errors from silicon waveguides due to fabrication variations, which become a major obstacle to practical deployments of very large-scale silicon photonic integrated chips. For small-scale integrations, active phase tuning schemes, which cause temporary phase corrections, can be used at the expense of extra power consumption. As integration scale grows, however, the total power consumed by active phase tuning can cause thermal dissipation issues and complicate control of tuning elements.

### SUMMARY

This disclosure relates to optical phase trimming for silicon or other photonic devices.

In some examples, a photonic component includes a substate and a dielectric layer disposed over the substrate. The photonic component also includes a waveguide section disposed within the dielectric layer and a heating element disposed within the dielectric layer and configured to transfer heat to the waveguide section. In addition, the photonic component includes one or more cavities in the substrate disposed below the waveguide section and the heating element, where the one or more cavities is configured to confine heat in an area of interest to reach an elevated temperature within and around the waveguide section.

Any single one or any combination of the following features may be used with the examples above. The heating element may be configured to increase a temperature of the waveguide section to a peak temperature at or above 450° C. to achieve a permanent change of an effective refractive index of the waveguide section by diffusing impurities into a silicon material of the waveguide section, annealing amorphous silicon of the waveguide section, annealing the dielectric layer to introduce a change in a mechanical stress of the dielectric layer and waveguide section, oxidizing the silicon material of the waveguide section, or a combination thereof. The heating element may include a doped crystalline silicon wire, a doped poly-silicon wire, a titanium nitride wire, an indium tin oxide layer, an electrically resistive metal trace embedded in a back-end-of-line (BEOL) stack, an active semiconductor device, or a combination thereof. The dielectric layer may include one or more impurities configured to cause enhanced permanent effective refractive index change of the waveguide section when heated using the heating element. The one or more impurities may include hydrogen, helium, carbon, germanium, boron, phosphide, or a combination thereof. The waveguide section may include amorphous silicon configured to cause enhanced permanent effective refractive index change of the waveguide section when heated using the heating element. The dielectric layer may include one or more oxidizing species configured to cause enhanced permanent effective refractive index change of the waveguide section when heated using the heating element. The dielectric layer may include silicon dioxide, silicon oxynitride, silicon nitride, fluorosilicate glass, borosilicate glass, phosphosilicate glass, borophosphosilicate glass, carbon doped oxide, one or more organic polymers, or a combination thereof and configured to cause enhanced permanent effective refractive index change of the waveguide section by a change of a mechanical stress in the waveguide section when heated using the heating element. The waveguide section may include silicon or silicon nitride, and the substrate layer may include silicon or glass. The photonic component may be coupled to a Mach-Zehnder interferometer, a Fabry-Pérot interferometer, a ring resonator, a switch, a wavelength filter, a waveguide coupler, or a modulator. The one or more cavities may be filled with one or more materials having a thermal conductivity of 0.1 W/mK or less.

In other examples, a feedback control system includes a plurality of photonic components, a power source coupled to the plurality of photonic components, and a laser coupled to the plurality of photonic components. Each of the plurality of photonic components includes a substate and a dielectric layer disposed over the substrate. Each of the plurality of photonic components also includes a waveguide section disposed within the dielectric layer and a heating element disposed within the dielectric layer and configured to transfer heat to the waveguide section. In addition, each of the plurality of photonic components includes one or more cavities in the substrate disposed below the waveguide section and the heating element, where the one or more cavities is configured to confine heat in an area of interest to reach an elevated temperature within and around the waveguide section.

Any single one or any combination of the following features may be used with the examples above. The power source may be coupled to the heating element of each of the plurality of photonic components and may be configured to provide driving power such that each heating element heats the respective waveguide section to a peak temperature at or above 450° C. to achieve a permanent change of an effective refractive index of the respective waveguide section by diffusing impurities into a silicon material of the waveguide section, annealing amorphous silicon of the waveguide section, adding mechanical stress to the waveguide section by annealing the dielectric layer, oxidizing the silicon material of the waveguide section, or a combination thereof. The waveguide section comprises amorphous silicon configured to cause enhanced permanent effective refractive index change of the waveguide section when heated using the heating element. The dielectric layer of the plurality of photonic components comprises one or more materials configured to cause enhanced permanent effective refractive index change of the waveguide section by a change of mechanical stress in the waveguide section, when heated using the heating element. The dielectric layer of each of the plurality of photonic components may include one or more oxidizing species configured to cause enhanced permanent effective refractive index change of the waveguide section when heated using the heating element.

In still other examples, a method includes setting a target phase of a photonic component. The photonic component includes a substate and a dielectric layer disposed over the substrate. The photonic component also includes a waveguide section disposed within the dielectric layer and a heating element disposed within the dielectric layer and configured to transfer heat to the waveguide section. The photonic component further includes one or more cavities in the substrate disposed below the waveguide section and the heating element, where the one or more cavities is configured to confine heat in an area of interest to reach an elevated temperature within and around the waveguide section. The method also includes measuring an optical phase of the photonic component and determining whether a difference between the target phase and the measured optical phase is within a specified tolerance. The method further includes, in response to determining that the difference is not within the specified tolerance, determining a heating time duration and providing power to the heating element for the heating time duration to permanently change an effective refractive index of the waveguide section.

Any single one or any combination of the following features may be used with the examples above. Measuring the optical phase of the photonic component may include using a laser and a photodetector configured to measure the optical phase of the photonic component. The heating element may be configured to increase a temperature of the waveguide section to a peak temperature at or above 450° C. to achieve the permanent change of the effective refractive index of the waveguide section by diffusing impurities into a silicon material of the waveguide section, annealing amorphous silicon of the waveguide section, changing a mechanical stress of the waveguide section by annealing of the dielectric layer, oxidizing the silicon material of the waveguide section, or a combination thereof.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1A illustrates a schematic top view of an example optical system supporting permanent correction of optical phase errors in accordance with this disclosure;

FIG. 1B illustrates a schematic top view of an example photonic component of the optical system of FIG. 1A in accordance with this disclosure;

FIG. 2A illustrates a schematic cross-sectional side view of a first portion of the example photonic component of FIG. 1B in accordance with this disclosure;

FIG. 2B illustrates a schematic cross-sectional side view of a second portion of the example photonic component of FIG. 1B in accordance with this disclosure;

FIG. 2C illustrates a schematic cross-sectional side view of a third portion of the example photonic component of FIG. 1B in accordance with this disclosure;

FIG. 3 illustrates an example method of optical phase trimming a photonic component for permanent optical phase shift in accordance with this disclosure; and

FIG. 4 illustrates an example feedback control system configured to perform at least part of the method of FIG. 3 in accordance with this disclosure.

### DETAILED DESCRIPTION

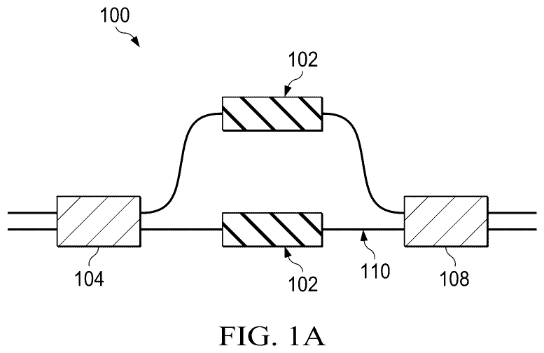

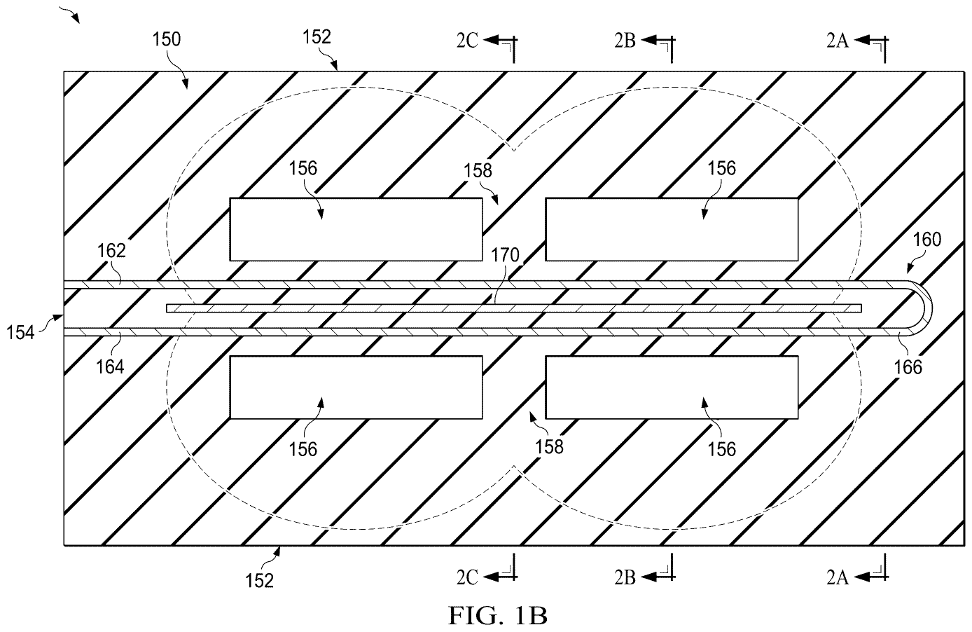

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, silicon photonics have been widely adopted in optical communication systems since silicon photonics often share fabrication infrastructures with complementary metal oxide semiconductor (CMOS) devices. Additionally, very high refractive index contrasts between silicon core layers and dielectric cladding layers used in silicon photonics enable large-scale and high-density integration on a single chip. However, high refractive index contrasts also cause phase errors from silicon waveguides due to fabrication variations, which become a major obstacle to practical deployments of very large-scale silicon photonic integrated chips. For small-scale integrations, active phase tuning schemes, which cause temporary phase corrections, can be used at the expense of extra power consumption. As integration scale grows, however, the total power consumed by active phase tuning can cause thermal dissipation issues and complicate control of tuning elements.

In phase-sensitive photonic devices such as modulators, optical filters, and optical switches, phase error caused by fabrication variations may be corrected by thermo-optic or electro-optic phase tuning, such as by using active phase tuning. However, the phase adjustment provided by active phase tuning vanishes once an energy source is removed. This means that phase correction using active phase tuning requires a continuous electrical power supply, which can lead to excess power consumption.

In addition to increased power consumption, active phase tuning often imposes performance degradation. For thermo-optic phase tuning, for example, the heat applied to an optical circuit can degrade the electrical and optical performance, such as the frequency response and insertion loss, of adjacent devices due to temperature elevation. For electro-optic phase tuning, excess free carriers, such as electrons or holes, injected into the device for phase tuning can lead to an increase in optical loss. Thus, the use of active phase tuning can hamper the scalability of photonic circuits, and the accumulated thermal dissipation, power consumption, and optical loss may actually render large-scale photonic circuits non-operable.

This disclosure provides various techniques for optical phase trimming for silicon or other photonic devices. As described in more detail below, these techniques can be used to achieve a permanent change of an effective refractive index of a waveguide section of a photonic component, resulting in a permanent optical phase shift in light propagating in the waveguide section. Among other things, this allows for phase adjustments to remain after an energy source is removed, thereby eliminating excess power consumption. Moreover, this can be achieved with little or no performance degradation to the corrected device and with little or no impact on the performance of adjacent devices.

FIG. 1A illustrates a schematic top view of an example optical system 100 supporting permanent correction of optical phase errors in accordance with this disclosure. The optical system 100 may represent any suitable optical device or system, such as a Mach-Zehnder interferometer as shown in FIG. 1A. However, in other embodiments, the optical system 100 may represent a photonic wavelength filter, a Fabry-Pérot interferometer, a ring resonator, a distributed Bragg reflector, an optical phase shifter, a switch, a wavelength multiplexer or demultiplexer, a mode multiplexer or demultiplexer, a waveguide section coupler, a modulator, or a phased array as examples.

As shown in FIG. 1A, the optical system 100 may include a plurality of photonic components 102 (also referred as an optical phase trimmable block) coupled to an optical input coupler 104. The plurality of photonic components 102 may also be coupled to an optical output coupler 108 using one or more optical connections 110. The output coupler 108 may be configured to receive optical outputs from the plurality of photonic components 102.

FIG. 1B illustrates a schematic top view of an example photonic component 102A of the optical system 100 of FIG. 1A in accordance with this disclosure. As described below, the photonic component 102A is configured for permanent optical phase correction or trimming. As shown in FIG. 1B, the photonic component 102A includes a component body 150 having one or more outer portions 152 and a central portion 154. The central portion 154 may be separate or delineated from the one or more outer portions 152 by one or more openings 156. The component body 150 may include one or more lateral arms 158 connecting the central portion 154 to each of the one or more outer portions 152 across the one or more openings 156 to provide structural support to the central portion 154. The component body 150 may also include a waveguide section 160 having a first waveguide subsection 162 and a second waveguide subsection 164 connected by a third waveguide subsection 166. The third waveguide subsection 166 may be curved (as shown) or have another geometry to guide light within the third waveguide subsection 166 from the first waveguide subsection 162 to the second waveguide subsection 164 or vice versa.

The component body 150 may further include one or more heating elements 170 disposed adjacent to the waveguide section 160, such as disposed between the first waveguide subsection 162 and the second waveguide subsection 164. The one or more heating elements 170 may be configured to increase a temperature of the waveguide section 160, such as to a peak temperature at or above 450° C. or other elevated temperature, to achieve a permanent change of an effective refractive index of the waveguide section 160. For example, the one or more heating elements 170 may include a doped crystalline silicon wire, a doped poly-silicon wire, a titanium nitride wire, an indium tin oxide layer, a metal trace embedded in a back-end-of-line (BEOL) stack, an active semiconductor device (such as a diode), or a combination thereof. The permanent refractive index change of the waveguide section may be caused by diffusing impurities into silicon, annealing of amorphous silicon, annealing the dielectric layer to change a mechanical stress of the waveguide section, oxidizing of silicon, or a combination thereof.

Although FIGS. 1A and 1B illustrate one example of an optical system 100 and a photonic component 102A supporting permanent correction of optical phase errors, various changes may be made to FIGS. 1A and 1B. For example, one or more heating elements 170 may be disposed in a different location relative to a waveguide section, such as on either side of the first waveguide subsection 162 and the second waveguide subsection 164. Doing so may allow fine tuning of the thermal profile provided to the waveguide section 160 by the one or more heating elements 170. Additionally, some embodiments may include a different number of waveguide sections, such as only one waveguide section without the “folded” configuration shown in FIG. 1B.

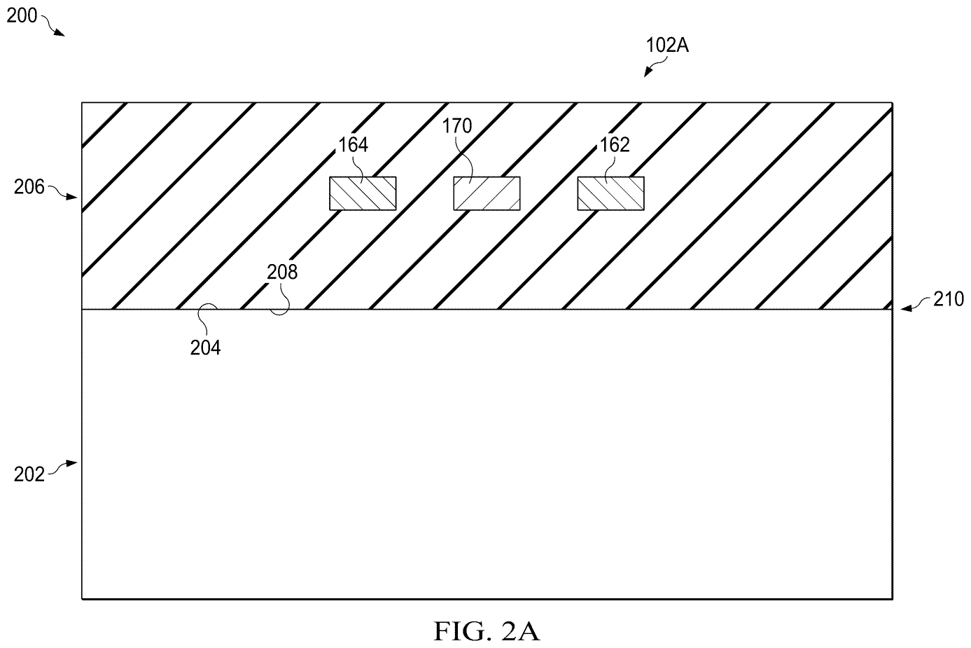

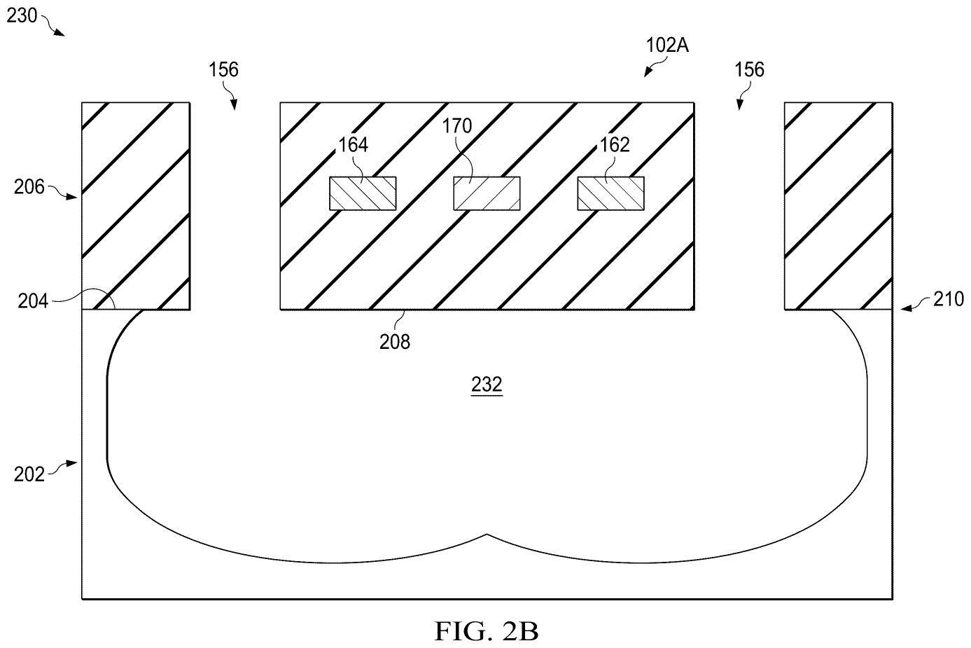

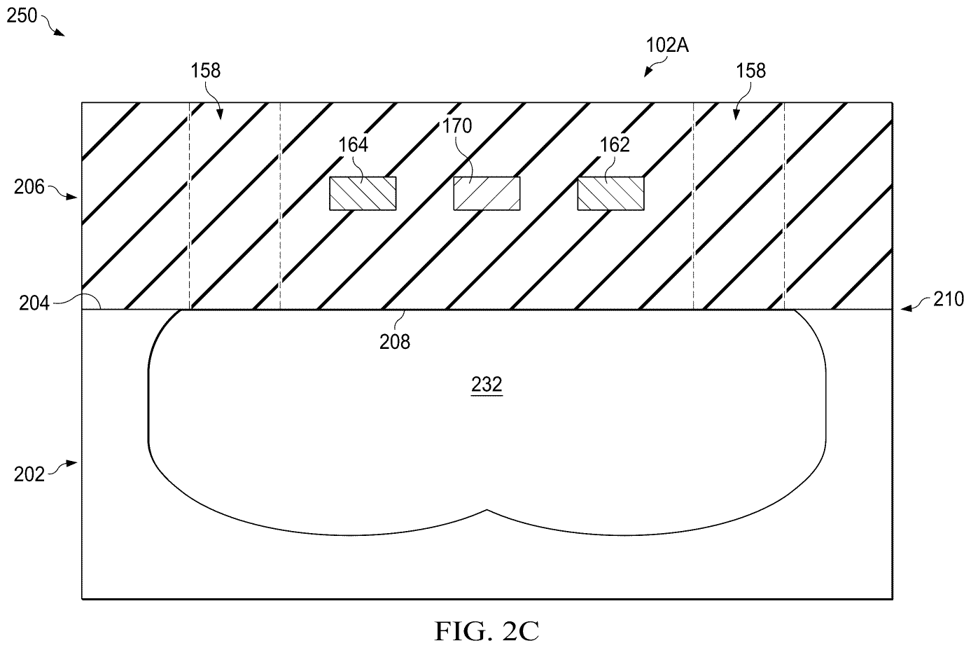

To further control a thermal profile of heating, such as the amount of heat applied to the waveguide section, the photonic component 102A includes a cavity to facilitate a temperature increase required for permanent optical phase trimming of the photonic component as shown in FIGS. 2A-2C.

FIG. 2A illustrates a schematic cross-sectional side view of a first portion 200 of the example photonic component 102A of FIG. 1B taken along line 2A in accordance with this disclosure. In particular, the first portion 200 illustrates a cross-sectional view of the photonic component 102A along an axis crossing the one or more outer portions 152, the central portion, and the waveguide section 160.

As shown in FIG. 2A, the photonic component 102A includes a substrate layer 202 having a surface 204. A dielectric layer 206 is disposed over the substrate layer 202 and has a first surface 208 contacting the surface 204 of the substrate layer 202 at an interface 210. The first waveguide subsection 162, the second waveguide subsection 164, and the one or more heating elements 170 can be embedded or encapsulated in the dielectric layer 206. The dielectric layer 206 may include one or more oxide or other dielectric materials, such as silicon dioxide, silicon oxynitride, silicon nitride, fluorosilicate glass, carbon doped oxide, one or more organic polymers, or other material(s) having a refractive index that is lower than the refractive index of the waveguide section 160.

In some embodiments, the waveguide section 160 may include a slab waveguide or a strip waveguide. The waveguide section 160 may include suitable waveguide materials, such as silicon or silicon nitride. The waveguide section 160 may also include one or more impurities that are introduced into the dielectric material of the dielectric layer 206 surrounding the waveguide section 160 to facilitate an effective index change due to heating. For instance, one or more impurities may be introduced during deposition of the dielectric layer 206, such as a cladding oxide layer. Examples of the one or more impurities may include hydrogen, helium, carbon, germanium, boron, phosphorous, or a combination thereof. The one or more impurities may also be introduced in any suitable manner. Examples may include carbon introduction from a tetraethyl orthosilicate (TEOS)-based plasma enhanced chemical vapor deposition (CVD) process for depositing a silicon dioxide dielectric layer, boron introduction during a borosilicate glass (BSG) CVD process, and phosphide introduction during a phosphosilicate glass (PSG) CVD process. The impurity introduction may include residual byproducts of some semiconductor fabrication processes. At high temperatures, the one or more impurities in the dielectric layer 206 can diffuse into the silicon material of the waveguide section 160 to change the refractive index of the waveguide section 160. The amount and type of impurities diffusing into the silicon waveguide determines the amount of effective index change of the waveguide.

In some embodiments, the waveguide section 160 may include additional amorphous silicon configured to enhance trimming efficiency of the waveguide section 160. In some cases, the amorphous silicon may be introduced by one or more additional processes, such as deposition of amorphous silicon around the waveguide section 160 or ion implantation that subsequently causes amorphization of silicon in the waveguide section 160. The amorphized silicon may be a byproduct of some semiconductor fabrication processes. At high temperatures, amorphized silicon can be partially or completely transformed into crystalline silicon to change the effective index of the waveguide section 160. The amount of amorphized silicon transformed into crystalline silicon determines the amount of effective index change of the waveguide section 160.

In some embodiments, the dielectric layer 206 in proximity to the waveguide section 160 may include one or more dielectric materials such that the mechanical stress in the dielectric layer changes permanently when annealed at a high temperature, such as at the peak temperature at or above 450°. For example, the one or more dielectric materials may include at least one of silicon dioxide, silicon oxynitride, or silicon nitride deposited using plasma-enhanced chemical vapor deposition (PECVD), where hydrogen may be introduced as an impurity during deposition. At high temperatures, the impurities in the one or more dielectric materials can desorb, which leads to a change of the mechanical stress in the dielectric layer 206. The change in mechanical stress of the dielectric layer causes a corresponding change in the mechanical stress of the material in the waveguide sections 160, and consequently a change in the effective index of the waveguide section 160 due to photo-elastic effects of the material, the one or more dielectric materials, or a combination thereof.

In some embodiments, the dielectric layer 206 in proximity to the waveguide section 160 may include one or more additional oxidizing species configured to oxidize silicon material in the waveguide section 160. For example, silicon dangling bonds may be included in the waveguide section 160 to enhance the silicon oxidization process. At high temperatures, the oxidizing species can oxidize the silicon material using the silicon dangling bonds to improve the oxidization process. In some cases, the oxidizing species, such as oxygen, may diffuse through silicon dioxide from the ambient environment and reach to the silicon material of the waveguide section 160. The amount of oxidized silicon determines the amount of effective index change of the waveguide.

FIG. 2B illustrates a schematic cross-sectional side view of a second portion 230 of the example photonic component 102A of FIG. 1B taken along line 2B in accordance with this disclosure. In particular, the second portion 230 illustrates a cross-sectional view of the photonic component 102A along an axis through the one or more outer portions 152, the central portion 154, and two of the one or more openings 156.

As shown in FIG. 2B, the photonic component 102A includes one or more cavities, such as a cavity 232, disposed or formed in the substrate layer 202 that ends at the interface 210, meaning the cavity 232 can be defined fully within the substrate layer 202. The one or more openings 156 in the dielectric layer 206 open into the cavity 232 such that the central portion 154, which contains the first waveguide subsection 162, the second waveguide subsection 164, and the one or more heating elements 170, is suspended over the cavity 232.

In some embodiments, the first waveguide subsection 162, the second waveguide subsection 164, and the one or more heating elements 170 are released from the substrate layer 202 to form the cavity 232 to reduce heat loss, thereby facilitating a temperature increase used for optical phase trimming as described later. In some cases, the cavity 232 may be formed by etching the substrate layer 202 using the one or more openings 156 in the dielectric layer 206 or by removing portions of the substrate layer 202 from the backside, such as by using a backside etching technique.

FIG. 2C illustrates a schematic cross-sectional side view of a third portion 250 of the example photonic component of FIG. 1B taken along line 2C in accordance with this disclosure. In particular, the third portion 250 illustrates a cross-sectional view of the photonic component 102A along an axis through the one or more lateral arms 158 between adjacent openings of the one or more openings 156.

As shown in FIG. 2C, the cavity 232 may be continuous under and along the central portion 154. The cavity 232 may also be disposed under the one or more lateral arms 158 that support the central portion 154. The cavity 232 allows for heat confinement during optical phase trimming. For example, heating elements in typical optical phase shifters are often designed to provide less than a 200° C. temperature increase. The one or more heating elements 170, in combination with the cavity 232, allow for an elevated temperature to be achieved, such as a temperature at or above about 450° C. In some cases, the elevated temperature may be significantly higher, such as about 800° C. The cavities shown in FIG. 2A-2C may be filled with one or more materials having a thermal conductivity of 0.1 W/mK or less, such as air. The low thermal conductivity material in the one or more cavities 232 acts as a thermal insulation layer, preventing damage or thermal transformation of the substrate layer 202 or other adjacent components.

The elevated temperature can be created by electrically powering the one or more heating elements 170 in the waveguide section 160 and the surrounding areas of the dielectric layer 206. The heat confinement provided by the cavity 232 reduces or prevents undesired changes and degradation of characteristics of nearby devices. For example, exposure to high temperatures may lead to performance degradation or damage to silicon photonic devices, such as modulators and photodetectors, due to dopant diffusion, crystal structural change, change in mechanical stress, or enhanced electromigration. Heat confinement may also reduce or avoid unwanted trimming from occurring in other trimmable devices, such as devices made of similar materials to the waveguide section 160, that are near to the one or more heating elements 170. As such, localized temperature increases enabled by the cavity 232 prevent excessive heat dissipation to nearby devices, thereby protecting these devices from degradation.

Although FIGS. 2A-2C illustrate one example of a photonic component 102A for supporting permanent trimming or correction of optical phase errors, various changes may be made to FIGS. 2A-2C. For example, the volume of the cavity 232 may be modified to achieve a desired heat confinement, or the cavity 232 may be divided into multiple smaller cavities to further refine heat confinement and achieve fine-tuned permanent optical phase trimming on different portions of the waveguide section 160. Additionally, the heating element position relative to the waveguide section can vary. For instance, the heating element can be above the waveguide section, or a portion of the waveguide can be doped and act as a heater.

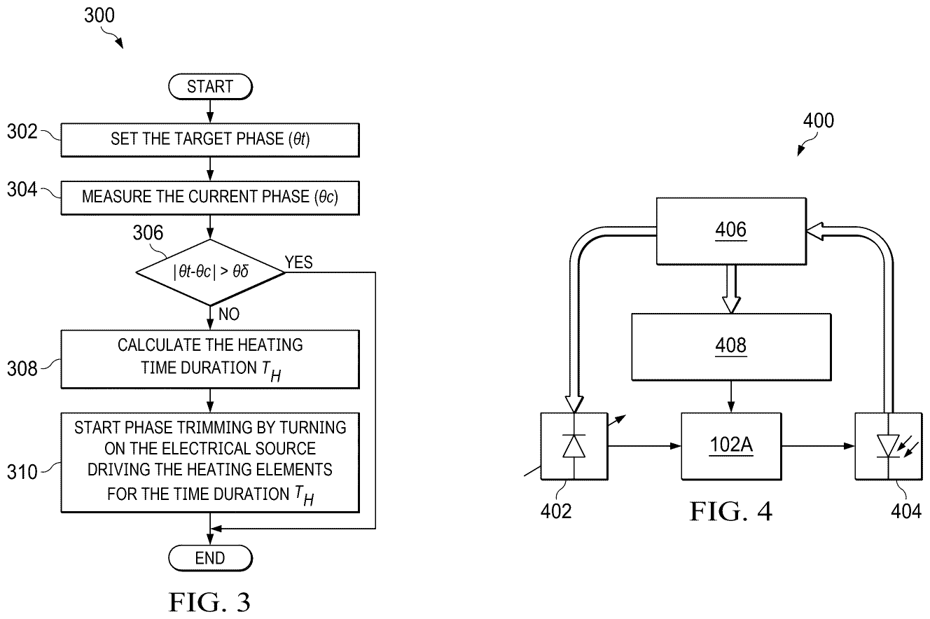

To achieve permanent optical phase trimming of a photonic component, the photonic component may undergo a method in which the one or more heating elements 170 heat the waveguide section 160 for a heating period until a desired phase shift is reached. One example of such a method is shown in FIG. 3. Also, a feedback control system may be used during the method 300 of FIG. 3 or other method to control the optical phase trimming of the photonic component. One example of such a feedback control system is shown in FIG. 4.

FIG. 3 illustrates an example method 300 of trimming a photonic component for permanent optical phase shift in accordance with this disclosure. More specifically, the method 300 can be used to increase the temperature of the waveguide section 160 of the photonic component 102A of FIGS. 2A-2C in order to facilitate a permanent effective index change in the waveguide section 160. FIG. 4 illustrates an example feedback control system 400 configured to perform at least part of the method 300 of FIG. 3 in accordance with this disclosure. For instance, the feedback control system 400 may perform at least part of the method 300 of FIG. 3 to trim the photonic component 102A of FIGS. 2A-2C.

As shown in FIG. 4, the feedback control system 400 may include a laser 402 and a photodetector 404 or other broadband optical source with an optical spectrometer. The laser 402 and the photodetector 404 may be coupled to the photonic component 102A. The laser 402 and the photodetector 404 are configured to measure the existing phase shift in the photonic component 102A. A controller 406 controls a power source 408 that is coupled to the photonic component 102A, such as by connecting a plurality of electrical pads (not shown) to the power source 408. The power source 408 supplies electrical power over a time duration based on the measured phase shift, where the electrical power is used by the one or more heating elements 170 to create localized heating within the photonic component 102A. The time duration may be determined by the controller 406 based on the difference between the measured phase shift and desired phase shift.

The controller 406 includes any suitable structure configured to process information and control trimming of photonic components. For instance, the controller 406 may include one or more processing devices, such as one or more microprocessors, microcontrollers, digital signal processors, field programmable gate arrays, application specific integrated circuits, or discrete logic devices. The controller 406 may also include one or more memories, such as a random access memory, read only memory, hard drive, Flash memory, optical disc, or other suitable volatile or non-volatile storage device(s). The controller 406 may further include one or more interfaces that support communications with other systems or devices, such as a network interface card or a wireless transceiver facilitating communications over a wired or wireless network or a direct connection.

As shown in FIG. 3, an operation 302 of the method 300 includes setting a target phase (θₜ) of the photonic component 102A. For example, the controller 406 may determine and set the target phase based on user input. In an operation 304, a current phase (θ_{c}) of the photonic component 102A is measured. For instance, the controller 406 may cause the laser 402 to emit light at a wavelength through the photonic component 102A to the photodetector 404. The photodetector 404 can send the received signal, transformed from the optical domain to the analog or digital domain, to the controller 406. The controller 406 can determine the current phase shift of the photonic component 102A based on the received signal at the photodetector 404.

In an operation 306, a difference θₑ between the target phase θₜ and the current phase θ_{c} of the photonic component 102A is calculated, such as by the controller 406 calculating the difference as θₑ=|θₜ−θ_{c}|. If the value of θₑ is within a specified tolerance θ_{δ}, the method 300 can end. In this case, the photonic component 102A is suitably trimmed or otherwise may not need additional trimming. Otherwise, the controller 406 determines that the photonic component 102A should undergo permanent optical phase trimming, and the method 300 proceeds to an operation 308.

In the operation 308, a heating time duration T_{H} is calculated, such as when the controller 406 uses a look-up table associating phase shifts and heating times. For example, if the current phase θ_{c} is smaller than a specified range but larger than the specified tolerance θ_{δ}, the heating time duration may be decreased to prevent overshoot. In an operation 310, power is provided to the photonic component 102A using the power source 408 coupled to the one or more heating elements 170 of the photonic component 102A for the heating time duration. This creates a permanent change to the effective refractive index of the waveguide section 160. In other words, the operation 310 starts phase trimming of the photonic component 102A, particularly the waveguide section 160, by using the power source 408 to drive the one or more heating elements 170 for the time duration T_{H}.

A permanent change to the effective refractive index of the waveguide section 160 can be achieved by mechanisms such as annealing of amorphous silicon in the waveguide section 160, impurity/dopant diffusion into the waveguide section 160, annealing of the one or more dielectric materials near the waveguide section 160, and silicon oxidation in the waveguide section 160. After heating of the photonic component 102A for the heating time duration by the one or more heating elements 170, the method 300 may optionally return to operation 304 to subsequently measure the optical phase of the photonic component 102A in order to determine an updated optical phase of the photonic component 102A. The method 300 may repeat operations 304-310 one or more times until the measured optical phase of the photonic component 102A is within the specified tolerance.

In some embodiments, the method 300 may leverage intrinsic material defects and impurities native to typical fabrication processes to achieve a permanent change in a waveguide, such as the waveguide section 160 of the photonic component 102A. These may include interface states between silicon and surrounding silicon dioxide, amorphized surfaces on silicon waveguides, residual oxidizing or hydrogenating species in proximity of waveguides, and impurities in surrounding cladding materials in dielectric layers 206. At elevated temperatures, the effective refractive index of a waveguide can be altered, such as due to annealing of the interface states or amorphous layers on silicon waveguides, oxidation of silicon, annealing of the one or more dielectric materials, or diffusion of impurities into the silicon of waveguide sections 160. This can change the charge densities, geometries, mechanical stresses, and/or material compositions of the waveguide sections 160. These mechanisms are generally irreversible, such as when reversal of these changes requires conditions (like temperatures) exceeding normal operating or storage conditions. As a result, these changes and their corresponding phase shifts can be permanent. The method 300 does not necessarily require additional process steps or a change in a process recipe to achieve permanent phase shifts of waveguide sections, so the method 300 may not incur additional complexity or cost compared to standard fabrication process.

Although FIG. 3 illustrates one example of a method 300 for trimming a photonic component for permanent optical phase shift, various changes may be made to FIG. 3. For example, while shown as a series of steps, various steps in FIG. 3 may overlap, occur in parallel, occur in a different order, or occur any number of times. As a particular example, various ones of steps 304-310 may occur repeatedly and in any desired order prior to phase trimming being completed.

Although FIG. 4 illustrates one example of a feedback control system 400 supporting trimming a photonic component for permanent optical phase shift, various changes may be made to FIG. 4. For example, computing devices and systems come in a wide variety of configurations, and FIG. 4 does not limit this disclosure to any particular computing device or system.

The present disclosure provides photonic components each having a waveguide section and one or more heating elements, which may be encapsulated in a dielectric layer and suspended over a cavity in an underlying substrate layer. In some cases, one or more on-chip electrical heating elements may be used to provide a permanent optical phase shift. Also, in some cases, one or more defects/impurities native to silicon fabrication process, such as the process used to fabricate the waveguide section, may be utilized to provide a permanent optical phase shift. As particular examples, interface states between silicon and surrounding silicon dioxide, an amorphized surface on a silicon waveguide, residual oxidizing or hydrogenating species in proximity of a waveguide, and/or one or more impurities in a surrounding cladding material (such as in the dielectric layer) may be introduced during normal semiconductor fabrication processes. The residuals of these undesirable sources can be used here to obtain a permanent material refractive index change through an elevated in-waveguide temperature provided by the one or more heating elements and fine-tuned by the cavity in the substrate layer.

The present disclosure may therefore improve optical phase trimming applicability to photonic circuits, such as by reducing yield loss due to extra processing steps, improving circuit trimming throughput by performing phase trimming operations in multiple parts of the circuit simultaneously using multiple electrically-driven permanent phase trimmers, and allowing in-field phase error corrections by integrating power sources and monitoring circuits into a larger system. Thus, in some cases, the present disclosure may allow for correction of circuit characteristic drift, such as due to aging and environmental condition changes.

The embodiments of the present disclosure are provided as mere illustrative examples and by no means represent the only applications of the disclosed photonic components or methods of trimming photonic components for permanent optical phase shift concepts. Various other photonic components and methods can readily be devised by those skilled in the art based on the contents of this disclosure.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A photonic component comprising:
a substrate layer;
a dielectric layer disposed over the substrate layer;
a waveguide section disposed within the dielectric layer;
a heating element disposed within the dielectric layer and configured to transfer heat to the waveguide section; and
one or more cavities in the substrate layer disposed below the waveguide section and the heating element, the one or more cavities configured to confine heat in an area of interest to reach an elevated temperature within and around the waveguide section.

2. The photonic component of claim 1, wherein the heating element is configured to increase a temperature of the waveguide section to a peak temperature at or above 450° C. to achieve a permanent change of an effective refractive index of the waveguide section by diffusing impurities into a silicon material of the waveguide section, annealing amorphous silicon of the waveguide section, annealing the dielectric layer to change a mechanical stress of the dielectric layer or of the waveguide section, oxidizing the silicon material of the waveguide section, or a combination thereof.

3. The photonic component of claim 1, wherein the heating element comprises a doped crystalline silicon wire, a doped poly-silicon wire, a titanium nitride wire, an indium tin oxide layer, an electrically resistive metal trace embedded in a back-end-of-line (BEOL) stack, an active semiconductor device, or a combination thereof.

4. The photonic component of claim 1, wherein the dielectric layer comprises one or more impurities configured to cause enhanced permanent effective refractive index change of the waveguide section when heated using the heating element.

5. The photonic component of claim 4, wherein the one or more impurities include hydrogen, helium, carbon, germanium, boron, phosphide, or a combination thereof.

6. The photonic component of claim 1, wherein the waveguide section comprises amorphous silicon configured to cause enhanced permanent effective refractive index change of the waveguide section when heated using the heating element.

7. The photonic component of claim 1, wherein the dielectric layer includes one or more oxidizing species configured to cause enhanced permanent effective refractive index change of the waveguide section when heated using the heating element.

8. The photonic component of claim 1, wherein the dielectric layer comprises silicon dioxide, silicon oxynitride, silicon nitride, fluorosilicate glass, borosilicate glass, phosphosilicate glass, borophosphosilicate glass, carbon doped oxide, one or more organic polymers, or a combination thereof and configured to cause enhanced permanent effective refractive index change of the waveguide section by a change of a mechanical stress in the waveguide section when heated using the heating element.

9. The photonic component of claim 1, wherein:
the waveguide section comprises silicon or silicon nitride; and
the substrate layer comprises silicon or glass.

10. The photonic component of claim 1, wherein the photonic component is coupled to a Mach-Zehnder interferometer, a Fabry-Pérot interferometer, a ring resonator, a switch, a wavelength filter, a waveguide coupler, or a modulator.

11. The photonic component of claim 1, wherein the one or more cavities are filled with at least one material having a thermal conductivity of 0.1 W/mK or less.

12. A feedback control system comprising:
a plurality of photonic components, each of the plurality of photonic components comprising:
a substrate layer;
a dielectric layer disposed over the substrate layer;
a waveguide section disposed within the dielectric layer;
a heating element disposed within the dielectric layer and configured to transfer heat to the waveguide section; and
one or more cavities in the substrate layer disposed below the waveguide section and the heating element, the one or more cavities configured to confine heat in an area of interest to reach an elevated temperature within and around the waveguide section;
a power source coupled to the plurality of photonic components; and
a laser coupled to the plurality of photonic components.

13. The feedback control system of claim 12, wherein the power source is coupled to the heating element of each of the plurality of photonic components and is configured to provide driving power such that each heating element heats the respective waveguide section to a peak temperature at or above 450° C. to achieve a permanent change of an effective refractive index of the respective waveguide section by diffusing impurities into a silicon material of the waveguide section, annealing amorphous silicon of the waveguide section, annealing the dielectric layer change a mechanical stress of the dielectric layer or of the waveguide section, oxidizing the silicon material of the waveguide section, or a combination thereof.

14. The feedback control system of claim 12, wherein the dielectric layer of each of the plurality of photonic components comprises one or more impurities configured to cause enhanced permanent effective refractive index change of the waveguide section when heated using the heating element.

15. The feedback control system of claim 12, wherein the waveguide section comprises amorphous silicon configured to cause enhanced permanent effective refractive index change of the waveguide section when heated using the heating element.

16. The feedback control system of claim 12, wherein the dielectric layer of each of the plurality of photonic components comprises one or more materials configured to cause enhanced permanent effective refractive index change of the waveguide section by a change of mechanical stress in the waveguide section, when heated using the heating element.

17. The feedback control system of claim 12, wherein the dielectric layer of each of the plurality of photonic components includes one or more oxidizing species configured to cause enhanced permanent effective refractive index change of the waveguide section when heated using the heating element.

18. A method comprising:
setting a target phase of a photonic component, wherein the photonic component comprises (i) a substrate, (ii) a dielectric layer disposed over the substrate, (iii) a waveguide section disposed within the dielectric layer, (iv) a heating element disposed within the dielectric layer and configured to transfer heat to the waveguide section, and (v) one or more cavities in the substrate disposed below the waveguide section and the heating element, the one or more cavities configured to confine heat in an area of interest to reach an elevated temperature within and around the waveguide section;
measuring an optical phase of the photonic component;
determining whether a difference between the target phase and the measured optical phase is within a specified tolerance; and
in response to determining that the difference is not within the specified tolerance:
determining a heating time duration; and
providing power to the heating element for the heating time duration to permanently change an effective refractive index of the waveguide section.

19. The method of claim 18, further comprising:
after providing the power to the heating element for the heating time duration, subsequently measuring the optical phase of the photonic component to determine an updated optical phase of the photonic component.

20. The method of claim 18, wherein the heating element is configured to increase a temperature of the waveguide section to a peak temperature at or above 450° C. to achieve a permanent change of an effective refractive index of the waveguide section by diffusing impurities into a silicon material of the waveguide section, annealing amorphous silicon of the waveguide section, annealing the dielectric layer to change a mechanical stress of the dielectric layer or of the waveguide section, oxidizing the silicon material of the waveguide section, or a combination thereof.
